(19) United States
(12) Patent Application Publication
(10) Pub. No.: US 2013/0067275 A1
(43) Pub. Date: Mar. 14, 2013

(54) VIDEO SERVER AND METHOD FOR CONTROLLING REBUILDING OF A DISK ARRAY

(71) Applicants: Hiroyuki Watanabe, Koganei-shi (JP); Toshiki Mori, Kodaira-shi (JP); Naoko Satoh, Hachioji-shi (JP)

(72) Inventors: Hiroyuki Watanabe, Koganei-shi (JP); Toshiki Mori, Kodaira-shi (JP); Naoko Satoh, Hachioji-shi (JP)

(21) Appl. No.: 13/557,965

(22) Filed: Jul. 25, 2012

(30) Foreign Application Priority Data
Sep. 8, 2011 (JP) 2011-196442

(51) Int. Cl. G06F 11/20; G06F 11/10

(52) U.S. Cl. 714/6.24; 714/6.22; 714/E11.098; 714/E11.032

(57) ABSTRACT

According to one embodiment, a video server includes an allocator. The allocator allocates resources for performing rebuilding. When processing which needs to be performed in real time is requested during the rebuilding, the allocator determines whether resources for performing the requested processing are available. When resources for performing the requested processing are available, the allocator allocates available resources to the requested processing. When resources for performing the requested processing are not available, the allocator deallocates resources allocated to the rebuilding to secure resources for performing the requested processing, and allocates the secured resources to the requested processing.

### CROSS-REFERENCE TO RELATED APPLICATIONS

This application is based upon and claims the benefit of priority from prior Japanese Patent Application No. 2011-196442, filed Sep. 8, 2011, the entire contents of which are incorporated herein by reference.

### FIELD

Embodiments described herein relate generally to a video server and a method for controlling the rebuilding of a disk array employed by the server.

### BACKGROUND

In recent years, the amount of data required to encode video content has increased as video quality has improved from high-definition, through full (2K×1K) and 4K (4K×2K) high-definition, to super (8K×4K) high-definition. In addition to this, the introduction of digital terrestrial broadcasting and digital direct broadcasting by satellite (DBS) has further increased the volume of data to be handled by increasing the number of channels over which content is broadcast.

To store, manage and retrieve this increased volume of content data, it has become increasingly common in recent years to have video servers store video content in file format. However, to maintain compatibility with conventional video servers, such file-oriented servers are configured to perform not only file recording but also stream recording.

Occurrence of a read failure when a video server is retrieving content recorded as a file or a stream is a serious problem since the content is meant for broadcast. Reading data reliably is therefore crucial, and to improve the reliability of reading, video servers are configured as redundant systems with a primary system and a backup system. However, such a dual-system approach greatly increases equipment cost, hindering the introduction of such servers to facilities such as local television stations and local cable providers.

Since video servers are essential in managing video content when broadcasting programs and commercials, such servers use Reed-Solomon encoding/decoding in order to store and retrieve video data accurately even if data errors occur. But if a storage device malfunctions, data errors of such severity can occur that Reed-Solomon encoding/decoding is unable to correct them. Therefore, video servers are additionally provided with Redundant Arrays of Independent Disks (RAID), along with a RAID-enabled rebuild function, in order to guarantee reliable storage and retrieval of video data.

In RAID-based video servers having a rebuild function, if a failure occurs in a storage device and the disk array must be rebuilt, a serious problem arises if the rebuilding interferes with the storage of new content or the retrieval of stored content. Therefore, the rebuilding is performed using only the minimum number of resources in order not to affect content storage or retrieval. However, if the failed storage device contained a large volume of content data, completing the rebuilding with the minimum number of resources takes a great deal of time, and a failure may occur in another storage device during the rebuilding, with the result that video data may fail to be stored or retrieved.

### BRIEF DESCRIPTION OF THE DRAWINGS

FIG. 1 shows the configuration of a video production system comprising a video server according to an embodiment;

FIG. 2 is a block diagram showing a functional configuration of the video server shown in FIG. 1;

FIG. 3 is a block diagram showing the functional configuration of the storage system shown in FIG. 2;

FIG. 4 is a block diagram showing the functional configuration of the RAID controller shown in FIG. 3;

FIG. 5 is a flowchart showing an example of the procedure carried out by the RAID controller when the video server shown in FIG. 1 performs rebuilding; and

FIG. 6 is a flowchart showing another example of the procedure carried out by the RAID controller when the video server shown in FIG. 1 performs rebuilding.

### DETAILED DESCRIPTION

In general, according to one embodiment, a video server includes storage devices, a read module, a restoration module, a redundant data adder, a write module, and an allocator. The plurality of storage devices store a plurality of data elements and redundant data. The data elements are obtained by dividing video data or a video file by Redundant Array of Independent Disks (RAID) control. The redundant data is used for restoring the data elements. When a storage device of the plurality of storage devices is replaced with a replacement storage device, the read module reads data elements and redundant data stored in the storage devices other than the replacement storage device. The restoration module restores data elements stored in the replaced storage device based on the read data elements and redundant data, and generates video data or a video file from the read data elements and the restored data elements. The redundant data adder divides, by the RAID control, the video data or video file generated by the restoration module into data elements, and generates redundant data for restoring the data elements. The write module writes in the replacement storage device the data elements and redundant data stored in the replaced storage device of the data elements and redundant data from the redundant data adder. The allocator allocates resources for performing rebuilding to the read module, the restoration module, the redundant data adder and the write module. When processing which needs to be performed in real time is requested during the rebuilding, the allocator determines whether resources for performing the requested processing are available. When the allocator determines that resources for performing the requested processing are available, the allocator allocates available resources to the requested processing. When the allocator determines that resources for performing the requested processing are not available, the allocator deallocates resources allocated to the rebuilding to secure resources for performing the requested processing, and allocates the secured resources to the requested processing.

### First Embodiment

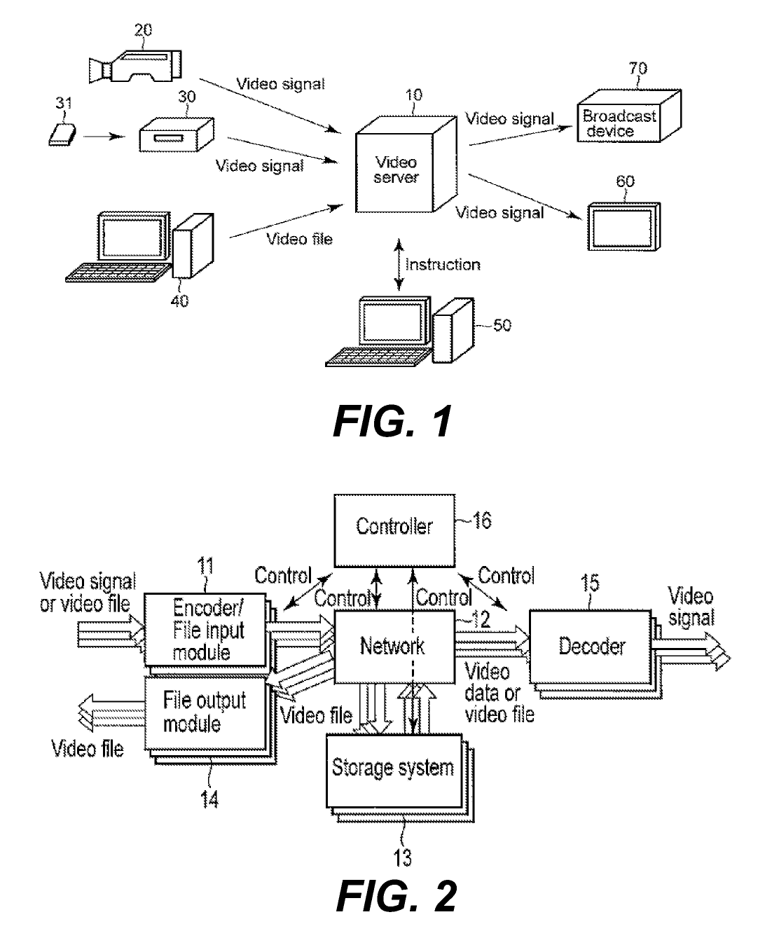

FIG. 1 is a schematic diagram showing the configuration of a video production system comprising a video server 10 according to the first embodiment. The video production system shown in FIG. 1 includes the video server 10, a video camera 20, a playback deck 30, a nonlinear editor 40, an operation terminal 50, a video monitor 60 and broadcasting equipment 70.

The video camera 20 outputs to the video server 10a a video signal obtained by capturing live action.

A video recording medium 31 storing video data or a video file is loaded into the playback deck 30. The video data represents a video signal encoded according to a predetermined encoding scheme. The video file is video data converted to file format. The playback deck 30 reads video data or a video file from the video recording medium 31, converts the video data or video file into a video signal, and outputs the video signal to the video server 10.

In accordance with a request from a user, the nonlinear editor 40 accesses a video file stored in the video server 10. The user edits the read video file with the nonlinear editor 40. The nonlinear editor 40 outputs the edited video file to the video server 10.

The operation terminal 50 receives a processing request from the user, and instructs the video server 10 to perform the process requested by the user. The process requested by the user includes, for example, recording a video signal, storing a video file, playing back a video signal, retrieving a video file, and rebuilding. Rebuilding is a process whereby, when one of a plurality of storage devices constituting a storage system in the video server 10 is replaced with a replacement storage device, data stored in the replaced storage device is rebuilt in the replacement storage device on the basis of data stored in the storage devices other than the replaced storage device.

The monitor 60 receives a video signal regenerated from a video data or a video file stored on the video server 10. The monitor 60 renders and displays the video signal received from the video server 10. The user checks, for example, the necessity of editing by viewing the monitor 60.

The broadcasting equipment 70 receives the video signal regenerated from the video data or the video file stored on the video server 10. The broadcasting equipment 70 transmits the video signal received from the video server 10 to an area provided with a broadcast service.

FIG. 2 is a block diagram showing a functional configuration of the video server 10 according to the present embodiment. The video server 10 shown in FIG. 2 includes an encoder/file input module 11, a network 12, a storage system 13, a file output module 14, a decoder 15 and a controller 16.

The encoder/file input module 11 receives an externally supplied video signal. The encoder/file input module 11 uses a predetermined encoding scheme to convert the received video signal into video data. In accordance with instructions from the controller 16, the encoder/file input module 11 outputs the video data via the network 12 to the storage system 13.

The encoder/file input module 11 also receives an externally supplied video file. The encoder/file input module 11 analyzes the received video file, and outputs an analysis result to the controller 16. For example, if the video file is a Material Exchange Format (MXF) file, the encoder/file input module 11 performs MX analysis on the received video file. In accordance with instructions from the controller 16, the encoder/file input module 11 outputs the analyzed video file via the network 12 to the storage system 13.

The encoder/file input module 11 includes a buffer which temporarily holds an externally supplied video file. When the storage system 13 performs flow control (to be described later) on the encoder/file input module 11, the encoder/file input module 11 temporarily holds the video file in the buffer.

The network 12 includes, for example, an Ethernet (registered trademark) switch. The switch transmits video data or a video file output from the encoder/file input module 11 to the storage system 13. The switch also transmits a video file read from the storage system 13 to the file output module 14. Further, the switch transmits video data or video file read from the storage system 13 to the decoder 15.

The file output module 14 outputs a video file supplied from the network 12. The file output module includes a buffer which temporarily holds a video file supplied from the network 12. When the storage system 13 performs flow control (to be described later) on the file output module 14, the file output module 14 outputs a predetermined volume of a video file redundantly held in the buffer or a predetermined number of video files redundantly held in the buffer.

The decoder 15 decodes video data supplied from the network 12 in accordance with the encoding method used in the encoder/file input module 11, thereby converting the video data into a video signal. The decoder 15 also converts a video file supplied from the network 12 into a video signal. The decoder 15 externally outputs the obtained video signal.

The controller 16 comprehensively controls the video server 10. The controller 16 receives, from the operation terminal 50, a stream recording instruction to record a video signal, a file storage instruction to store a video file, a stream playback instruction to play back a video signal, a file retrieval instruction to retrieve a video file, and a rebuild instruction to rebuild the disk array.

Upon receipt of the stream recording instruction, the controller 16 controls stream recording on the encoder/file input module 11, the network 12 and the storage system 13 to record a video signal, while monitoring the conditions of the network 12 and the storage system 13.

Upon receipt of the file recording instruction, the controller 16 controls file recording on the encoder/file input module 11, the network 12 and the storage system 13 to record a video file, while monitoring the conditions of the network 12 and the storage system 13.

Upon receipt of the video signal playback instruction, the controller 16 controls reproduction on the network 12, the storage system 13 and the decoder to reproduce a video signal, while monitoring the conditions of the network 12 and the storage system 13.

Upon receipt of the video file retrieval instruction, the controller 16 controls output on the network 12, the storage system 13 and the file output module 14 to retrieve a video file, while monitoring the conditions of the network 12 and the storage system 13.

Upon receipt of the rebuild instruction, the controller 16 controls rebuilding on the storage system 13 to rebuild the disk array.

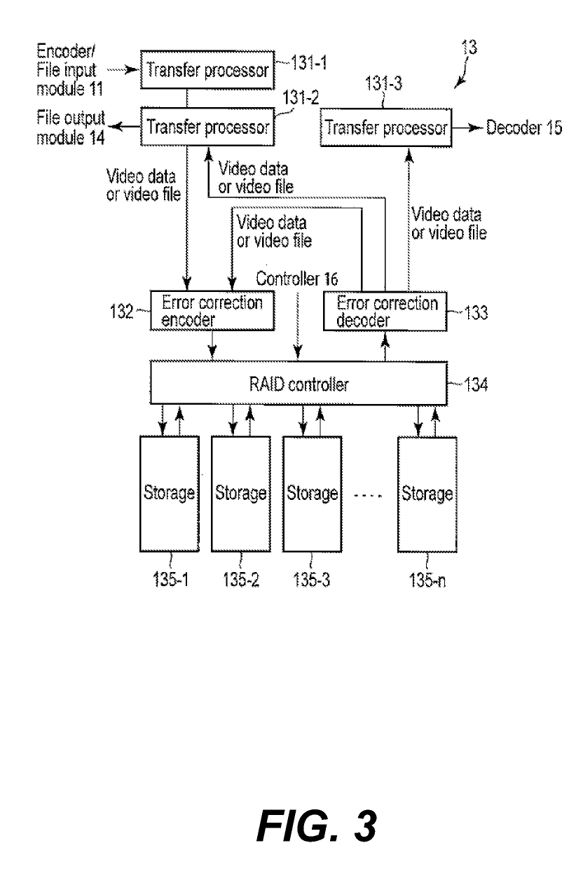

FIG. 3 is a block diagram showing a functional configuration of the storage system 13 of the video server 10 according to the present embodiment. The storage system 13 shown in FIG. 3 includes transfer processors 131-1 to 131-3, an error correction encoder 132, an error correction decoder 133, a RAID controller 134, and storage devices 135-1 to 135-n.

Transfer processor 131-1 transfers video data and a video file to the encoder/file input module 11. Specifically, when stream recording is performed, transfer processor 131-1 outputs video data supplied from the encoder/file input module 11 to the error correction encoder 132 via the network 12. When file storage is performed, transfer processor 131-1 transfers a video file supplied from the encoder/file input module 11 to the error correction encoder 132 via the network 12.

Transfer processor 131-2 transfers a video file to the file output module 14. Specifically, when output processing is performed, transfer processor 131-2 outputs a video file supplied from the error correction decoder 133 to the file output module 14 via the network 12.

Transfer processor 131-3 transfers video data and a video file to the decoder 15. Specifically, when reproduction is performed, transfer processor 131-3 outputs video data or a video file supplied from the error correction decoder 133 to the decoder 15 via the network 12.

When stream recording is performed, the error correction encoder 132 encodes video data supplied from transfer processor 131-1 with an error correction code capable of burst error correction. The error correction code capable of burst error correction is, for example, a Reed-Solomon correction code. The error correction encoder 132 outputs the video data subjected to error correction encoding to the RAID controller 134.

When file storage is performed, the error correction encoder 132 performs error correction encoding on a video file supplied from transfer processor 131-1. The error correction encoder 132 outputs the video file subjected to error correction encoding to the RAID controller 134.

When rebuilding is performed, the error correction encoder 132 receives video data or a video file subjected to error correction decoding at the error correction decoder 133, and performs error correction encoding on the received video data or video file.

The error correction encoder 132 includes a buffer which temporarily holds video data or a video file under error correction encoding. When a priority controller 1347 (to be described later) performs priority control on the error correction encoder 132, the error correction encoder 132 temporarily holds the video data or video file in the buffer.

When file retrieval is performed, the error correction decoder 133 performs error correction on a video file supplied from the RAID controller 134 based on an error correction code added by the error correction encoder 132. The error correction decoder 133 outputs the video file subjected to error correction decoding to transfer processor 131-2.

When stream playback is performed, the error correction decoder 133 performs error correction on video data or a video file from the RAID controller 134 based on an error correction code added by the error correction encoder 132. The error correction decoder 133 outputs the video data or video file subjected to error correction decoding to transfer processor 131-3.

When rebuilding is performed, the error correction decoder 133 performs error correction on video data or a video file supplied from the RAID controller 134 based on an error correction code added by the error correction encoder 132. The error correction decoder 133 outputs the video data or video file subjected to error correction decoding to the error correction encoder 132.

The error correction decoder 133 includes a buffer which temporarily holds video data or a video file under error correction decoding. When a priority controller 1347 (to be described later) performs priority control on the error correction decoder 133, the error correction decoder 133 temporarily holds the video data or video file in the buffer.

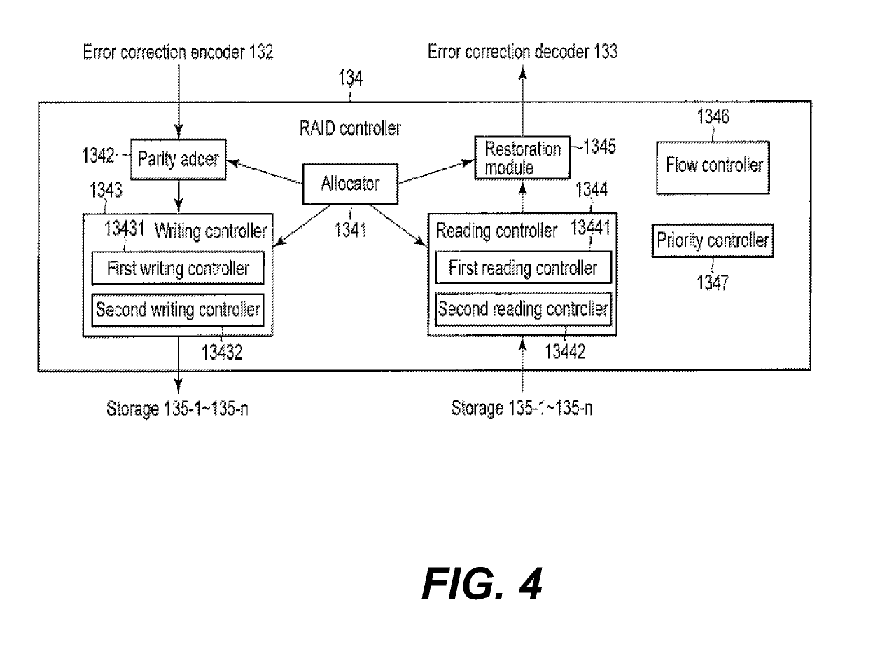

The RAID controller 134 includes, for example, a field programmable gate array (FPGA), and controls writing of video data and a video file in the storage devices 135-1 to 135-n, and reading of video data and a video file stored in the storage devices 135-1 to 135-n. FIG. 4 is a block diagram showing a functional configuration of the RAID controller 134 according to the present embodiment. The RAID controller 134 shown in FIG. 4 includes an allocator 1341, a parity adder 1342, a write controller 1343, a read controller 1344, a restoration module 1345, a flow controller 1346, and a priority controller 1347.

When the controller 16 controls stream recording, file storage, stream playback, file retrieval or rebuilding on the allocator 1341, the allocator 1341 allocates resources to processing corresponding to the control. The resources are those required when the video server 10 performs processing, which are determined based on, for example, the write speed and read speed of the storage devices 135-1 to 135-n, the processing capability of the RAID controller 134, and the data transfer capability of the network 12. Accordingly, the number of resources influences the number of processes the video server 10 can perform in parallel.

For example, stream recording and playback must be performed in real time. Therefore, when the controller controls stream recording or playback on the allocator 1341, the allocator 1341 allocates a fixed number of resources to the stream recording or playback. In contrast, file storage, retrieval and rebuilding need not be performed in real time. Therefore, when the controller 16 controls file storage, retrieval or rebuilding on the allocator 1341, the allocator 1341 allocates all available resources to the storage, retrieval or rebuilding on the basis of a best effort method.

When the controller 16 controls stream recording or playback in real time on the allocator 1341 during rebuilding, the allocator 1341 determines whether resources for performing processing corresponding to the control are available. If resources are available, the allocator 1341 allocates available resources to the processing corresponding to the control. If resources are not available, the allocator 1341 deallocates some resources allocated to rebuilding being performed to secure resources for performing the processing corresponding to the control. The allocator 1341 allocates the secured resources to the processing corresponding to the control.

When the controller 16 controls stream recording, file recording or rebuilding on the parity adder 1342, the parity adder 1342 uses allocated resources to divide video data or a video file supplied from the error correction encoder 132 into (n−1) data elements. The parity adder 1342 generates parity data, which is redundant data, based on the generated (n−1) data elements.

The write controller 1343 includes a first write controller 13431 and a second write controller 13432.

When the controller 16 controls stream recording or file storage on the first write controller 13431, the first write controller 13431 uses allocated resources to control writing of data elements and parity data in the storage devices 135-1 to 135-n. To prevent parity data from being written in the same storage device, the first write controller 13431 sequentially switches the storage device to store parity data between the storage devices 135-1 to 135-n.

When the controller 16 controls rebuilding on the second write controller 13432, the second write controller 13432 uses allocated resources to perform control to write data elements and parity data restored by the restoration module 1345 in the replacement storage device.

The read controller 1344 includes a first read controller 13441 and a second read controller 13442.

When the controller 16 controls stream playback or file retrieval on the first read controller 13441, the first read controller 13441 uses allocated resources to control reading of data elements and parity data from the storage devices 135-1 to 135-n.

When the controller 16 controls rebuilding on the second read controller 13442, the second read controller 13442 uses allocated resources to control reading of data elements and parity data stored in the storage devices other than the replaced storage device.

When the controller 16 controls stream playback or file retrieval on the restoration module 1345, the restoration module 1345 uses allocated resources to receive data elements and parity data read from the storage devices 135-1 to 135-n in accordance with the read control of the first read controller 13441. When the restoration module 1345 successfully receives (n−1) data elements, the restoration module 1345 combines the (n−1) data elements to generate video data or a video file, and outputs the generated video data or video file to the error correction decoder 133.

When one of the received data elements includes an error, or one of the data elements cannot be received, the restoration module 1345 restores the data element including an error or the missing data element based on the successfully received (n−2) data elements and parity data. The restoration module 1345 combines the (n−2) data elements and the restored data element to generate video data or a video file, and outputs the generated video data or video file to the error correction decoder 133.

When the controller 16 controls rebuilding on the restoration module 1345, the restoration module 1345 uses allocated resources to receive data elements and parity data read from the storage devices other than the replaced storage device in accordance with the read control of the second read controller 13442. The restoration module 1345 restores the data elements and parity data stored in the replaced storage device on the basis of the received data elements and parity data. The restoration module 1345 combines (n−1) data elements including the restored data element to generate video data or a video file, and outputs the generated video data or video file to the error correction decoder 133.

When the controller 16 controls file storage as a non-real-time process on the flow controller 1346 during rebuilding, the flow controller 1346 performs flow control on the encoder/file input module 11 to cause the encoder/file input module 11 to temporarily hold a received video file in the buffer. Further, when the controller 16 controls file retrieval as a non-real-time process on the flow controller 1346 during rebuilding, the flow controller 1346 performs flow control on the file output module 14 to cause the file output module 14 to output a video file temporarily held in the buffer.

When the controller 16 controls stream recording or playback in real time on the priority controller 1347 while error correction encoding is being performed by the error correction encoder 132 on video data or a video file for rebuilding, the priority controller 1347 performs priority control on the error correction encoder 132 to cause the error correction encoder 132 to temporarily hold, in the buffer, the video data or video file under processing.

When the controller 16 controls stream recording or playback in real time on the priority controller 1347 while error correction decoding is being performed by the error correction decoder 133 on video data or a video file for rebuilding, the priority controller 1347 performs priority control on the error correction decoder 133 to cause the error correction encoder 133 to temporarily hold, in the buffer, the video data or video file under processing.

When stream recording or file storage is being performed, the storage devices 135-1 to 135-n store data elements and parity data in accordance with write control of the first write controller 13431.

When stream playback or file retrieval is being performed, the storage devices 135-1 to 135-n output stored data elements and parity data in accordance with read control of the first read controller 13441.

Of the storage devices 135-1 to 135-n, the storage devices other than the replaced storage device output, when rebuilding is performed, stored data elements and parity data in accordance with read control of the second read controller 13442. Of the storage devices 135-1 to 135-n, the replacement storage device stores, when rebuilding is performed, data elements and parity data in accordance with write control of the second write controller 13432.

Next, rebuilding performed by the video server 10 configured as described above will be described following the procedure performed by the RAID controller 134.

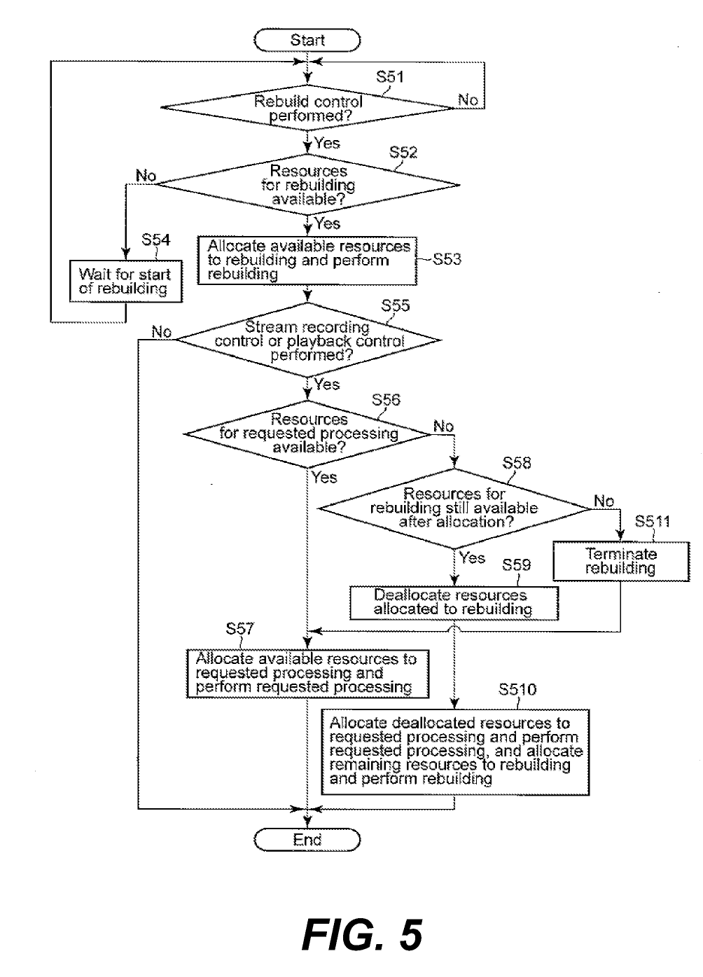

FIG. 5 is a flowchart showing a procedure performed by the RAID controller 134 when the video server 10 performs rebuilding. Described below is a case where rebuilding is controlled while stream recording or playback is controlled in real time.

The RAID controller 134 determines whether the controller 16 is performing rebuild control (step S51). When the RAID controller 134 determines that the controller 16 is performing rebuild control (Yes in step S51), the allocator 1341 determines whether resources for performing rebuilding are available (step S52). When the RAID controller 134 determines that the controller 16 is not performing rebuild control (No in step S51), the RAID controller 134 repeats step S51.

When the allocator 1341 determines that resources for performing rebuilding are available in step S52 (Yes in step S52), the allocator 1341 allocates available resources to rebuilding. The second read controller 13442, the restoration module 1345 and the second write controller 13432 use the allocated available resources to reconfigure, in the replacement storage device, the data stored in the replaced storage device on the basis of the data elements and parity data stored in the storage devices other than the replaced storage device. More specifically, the second read controller 13442 reads the data elements and parity data stored in the storage devices other than the replaced storage device. The restoration module 1345 restores the data elements and parity data stored in the replaced storage device. The second write controller 13432 stores the restored data elements and parity data in the replacement storage device (step S53). When the allocator 1341 determines that resources for performing rebuilding are not available in step S52 (No in step S52), the RAID controller 134 stands by until completion of the processing being performed (step S54) and performs step S51.

Next, the RAID controller 134 determines whether stream recording or playback is being controlled in real time (step S55). If the RAID controller 134 determines that stream recording or playback is being controlled (Yes in step S55), the allocator 1341 determines whether resources for stream recording or playback are available (step S56). If the RAID controller 134 determines that stream recording or playback is not being controlled (No in step S55), the RAID controller 134 ends processing.

If the allocator 1341 determines that resources for stream recording or playback are available in step S56 (Yes in step S56), the allocator 1341 allocates available resources to the stream recording or playback. If stream recording is performed, the parity adder 1342 and the first write controller 13431 use the allocated resources to store video data from the error correction encoder 132 in the storage devices 135-1 to 135-n. If stream playback is performed, the first read controller 13441 and the restoration module 1345 use the allocated resources to generate video data or a video file based on the data elements and parity data stored in the storage devices 135-1 to 135-n, and output the generated video data or video file to the error correction decoder 133 (step S57).

When the allocator 1341 determines that resources for stream recording or playback are not available in step S56 (No in step S56), the allocator 1341 allocates resources to the stream recording or playback control instead of rebuilding, and determines whether resources for rebuilding are still available (step S58). When the allocator 1341 determines that resources to allocate to rebuilding are still available (Yes in step S58), the allocator 1341 deallocates resources necessary for stream recording or playback of the resources allocated to rebuilding (step S59), allocates the deallocated resources to the stream recording or playback, and allocates the remaining resources to the rebuilding. When stream recording is performed, the parity adder 1342 and the first write controller 13431 use the allocated resources to store video data from the error correction encoder 132 in the storage devices 135-1 to 135-n. When playback is performed, the first read controller 13441 and the restoration module 1345 use the allocated resources to generate video data or a video file based on the data elements and parity data stored in the storage devices 135-1 to 135-n, and output the generated video data or video file to the error correction decoder 133. When rebuilding is performed, the second read controller 13442, the restoration module 1345 and the second write controller 13432 use the allocated remaining resources to reconfigure, in the replacement storage device, the data stored in the replaced storage device on the basis of the data elements and parity data stored in the storage devices other than the replaced storage device (step S510). When the allocator 1341 determines that resources to allocate to rebuilding are not available (No in step S58), the allocator 1341 terminates rebuilding (step S511) and moves the processing to step S57.

Further, the size of the rebuilding is reduced in step S59, and the rebuilding is terminated in step s511. Therefore, the priority controller 1347 performs priority control on the error correction encoder 132 and the error correction decoder 133 to cause the error correction encoder 132 and the error correction decoder 133 to temporarily hold, in their buffers, video data or a video file for rebuilding.

When the controller 16 controls file storage or retrieval as a non-real-time process on the RAID controller 134, the RAID controller 134 must suspend file storage or retrieval until rebuilding is complete. When the controller 16 controls file recording on the flow controller 1346 during rebuilding, the flow controller 1346 controls flow on the encoder/file input module 11. Further, when the controller 16 controls output on the flow controller 1346 during rebuilding, the flow controller 1346 controls flow on the file output module 14.

File storage and retrieval are not real-time processes, and thus are performed in the best effort method. If the processing fails halfway, salvaging, such as retry processing is performed.

As described above, in the present embodiment, when real-time processing is requested during rebuilding, the allocator 1341 deallocates resources allocated to the rebuilding, and allocates the deallocated resources to the requested processing. This configuration allows resources to be dynamically allocated to rebuilding. Accordingly, the resources allocated to rebuilding need not be limited to the minimum resources that will not affect real-time processing, and rebuilding does not require a great deal of time. Further, the configuration can reduce the risk that a video stream cannot be recorded or played back, or a video file cannot be stored or retrieved, if another storage device fails during rebuilding.

In the present embodiment, the error correction encoder 132 and the error correction decoder 133 each include a buffer that temporarily holds video data or a video file being processed when real-time processing is requested during rebuilding. This configuration enables dynamically changing resources allocated to rebuilding. Accordingly, even if real-time processing is requested during rebuilding, the rebuilding can be prevented from affecting the requested processing.

In the present embodiment, the encoder/file input module 11 includes a buffer, and when non-real-time file recording is requested during other processing, the flow controller 1346 temporarily holds a supplied video file in the buffer. In addition, the file output module 14 includes a buffer, and when non-real-time output processing is requested during other processing, the flow controller 1346 outputs a video file held in the buffer. This configuration can prevent processing from being delayed when non-real-time processing is requested during rebuilding.

Therefore, the video server 10 according to the present embodiment can perform rebuilding using RAID without affecting stream recording of new content and stream playback of recorded content.

The present embodiment describes the case where the write controller 1343 and the read controller 1344 do not include a buffer. However, the video server 10 may have a different configuration, and the write controller 1343 and the read controller 1344 may each include a buffer. When the controller 16 controls stream recording or playback on the priority controller 1347 while data elements and parity data for rebuilding are being written in the replacement storage device by the second write controller 13432, the priority controller 1347 performs priority control on the write controller 1343 to cause the write controller 1343 to temporarily hold, in the buffer, the data elements and parity data under processing. Further, when the controller 16 controls stream recording or playback on the priority controller 1347 while data elements and parity data for rebuilding are being read by the second read controller 13442 from the storage devices other than the replacement storage device, the priority controller 1347 performs priority control on the read controller 1344 to cause the read controller 1344 to temporarily hold, in the buffer, the data elements and parity file under processing.

Further, described in the present embodiment is the case where, when real-time stream recording or reproduction playback is requested during rebuilding, the RAID controller 134 performs the requested stream recording or playback prior to rebuilding. However, the video server 10 may have a different configuration. For example, the video server 10 may have a configuration in which even when non-real-time file storage or retrieval is requested during rebuilding, the requested file storage or retrieval is performed prior to rebuilding.

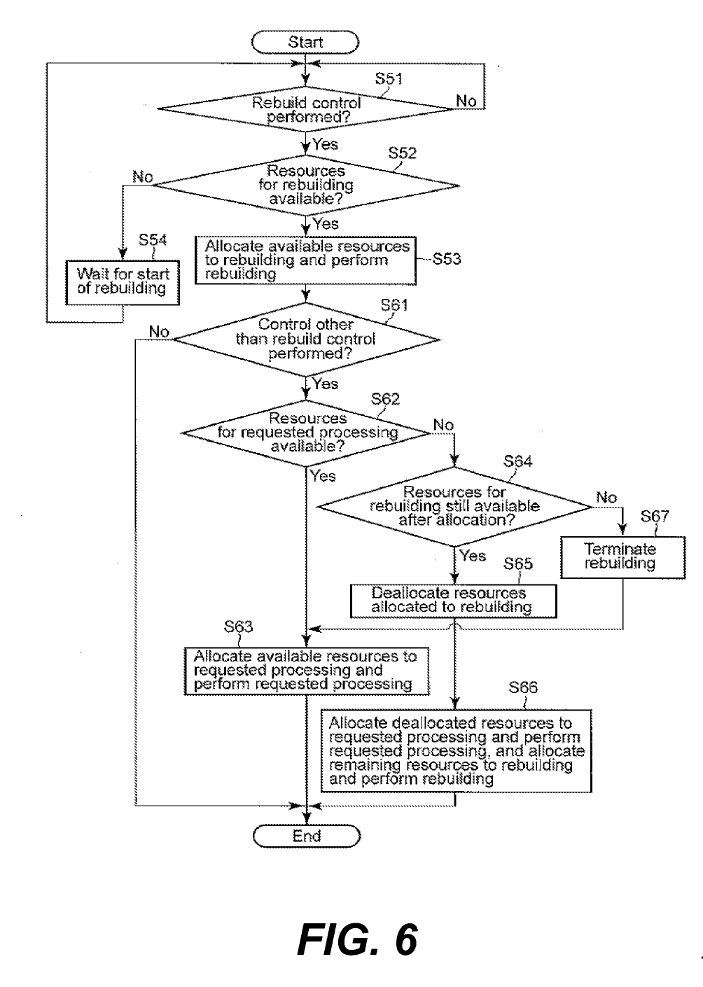

FIG. 6 is a flowchart showing another procedure performed by the RAID controller 134 when the video server 10 performs rebuilding. Steps S51 to S54 are the same as those shown in FIG. 5.

After step S53, the RAID controller 134 determines whether the controller 16 is controlling, for example, stream recording, file storage, stream playback or file retrieval, in other words, control other than that for rebuilding (step S61). If the RAID controller 134 determines that the controller 16 is controlling a process other than rebuilding (Yes in step S61), the allocator 1341 determines whether resources for the requested process are available (step S62). If the RAID controller 134 determines that the controller 16 is controlling rebuilding (No in step S61), the RAID controller 134 ends processing.

When the allocator 1341 determines that resources for performing requested processing are available in step S62 (Yes in step S62), the allocator 1341 allocates available resources to the requested processing. The RAID controller 134 uses the resources allocated by the allocator 1341 to perform the requested processing (step S63).

When the allocator 1341 determines that resources for performing requested processing are not available in step S62 (No in step S62), the allocator 1341 allocates resources to the requested processing instead of rebuilding, and then determines whether resources to allocate to rebuilding are still available (step S64). When the allocator 1341 determines that resources to allocate to rebuilding are still available (Yes in step S64), the allocator 1341 deallocates resources necessary for the requested processing of the resources allocated to rebuilding (step S65), allocates the deallocated resources to the requested processing, and allocates the remaining resources to rebuilding. The RAID controller 134 uses the resources allocated by the allocator 1341 to perform the requested processing in parallel with rebuilding (step S66). When the allocator 1341 determines that resources to allocate rebuilding are not available (No in step S64), the allocator 1341 terminates rebuilding (step S67) and moves the processing to step S63.

Accordingly, when processing other than rebuilding is requested during rebuilding, the allocator 1341 deallocates resources allocated to rebuilding, and allocates the deallocated resources to the requested processing. This configuration enables dynamically changing resources allocated to rebuilding in accordance with the requested processing. Consequently, the resources allocated to rebuilding need not be limited to the minimum resources to such an extent that stream recording, file storage, stream playback or file retrieval is not affected.

Described in the present embodiment is the case where the encoder/file input module 11 includes a buffer which temporarily holds a video file externally supplied, and the file output module 14 includes a buffer which temporarily holds a video file supplied from the network 12. However, the video server 10 may have a different configuration. For example, the video server 10 may have a configuration in which the encoder/file input module 11 includes a buffer which temporarily holds converted video data, and the decoder 15 includes a buffer which temporarily holds video data or a video file supplied from the network 12.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video server comprising:
a plurality of storage devices configured to store a plurality of data elements and redundant data, the data elements being obtained by dividing video data or a video file by Redundant Array of Independent Disks (RAID) control, the redundant data being used for restoring the data elements;
an allocator configured to:
allocate resources for performing rebuilding;
when processing which needs to be performed in real time is requested during the rebuilding, determine whether resources for performing the requested processing are available;
when the allocator determines that resources for performing the requested processing are available, allocate available resources to the requested processing;
when the allocator determines that resources for performing the requested processing are not available, deallocate resources allocated to the rebuilding to secure resources for performing the requested processing, and allocate the secured resources to the requested processing.

2. The video server of claim 1, further comprising:
a read controller configured to, when a storage device of the plurality of storage devices is replaced with a replacement storage device, read data elements and redundant data stored in the storage devices other than the replacement storage device;
a restoration device configured to restore data elements stored in the replaced storage device based on the read data elements and redundant data, and generate video data or a video file from the read data elements and the restored data elements;
a redundant data adder configured to divide, by the RAID control, the video data or video file generated by the restoration module into data elements, and generate redundant data for restoring the data elements; and
a write controller configured to write in the replacement storage device the data elements and redundant data stored in the replaced storage device of the data elements and redundant data from the redundant data adder;
wherein the allocator is configured to allocated resources to the read module, the restoration module, the redundant data adder and the write module and wherein the allocator allocates a fixed number of resources to processing which needs to be performed in real time.

3. The video server of claim 1, further comprising:
an error correction decoder configured to perform error correction decoding on the video data or video file generated by the restoration module, based on an error correction code;
an error correction decoder configured to add an error correction code to the video data or video file subjected to the error correction decoding, and output the video data or video file including the error correction code to the redundant data adder; and
a priority controller configured to, when processing which needs to be performed in real time is requested during the error correction decoding in the rebuilding, cause the error correction encoder to temporarily hold the video data or video file under the error correction decoding.

4. The video server of claim 1, further comprising:
an error correction decoder configured to perform error correction decoding on the video data or video file generated by the restoration module, based on an error correction code;
an error correction decoder configured to add an error correction code to the video data or video file subjected to the error correction decoding, and output the video data or video file including the error correction code to the redundant data adder; and
a priority controller configured to, when processing which needs to be performed in real time is requested during the addition of an error correction code in the rebuilding, cause the error correction encoder to temporarily hold the video data or video file under the addition of an error correction code.

5. The video server of claim 1, further comprising a priority controller configured to, when processing which needs to be performed in real time is requested while the data elements and redundant data stored in the replaced storage device are being written in the replacement storage device in the rebuilding, cause the write module to temporarily hold the video data or video file under the writing.

6. The video server of claim 1, further comprising a priority controller configured to, when processing which needs to be performed in real time is requested while the data elements and redundant data stored in the storage devices other than the replacement storage device are being read in the rebuilding, cause the read module to temporarily hold the video data or video file under the reading.

7. The video server of claim 1, further comprising a flow controller configured to, when file storage for storing a video file, which need not be performed in real time, is requested during the rebuilding, perform flow control to suspend the file storage.

8. The video server of claim 1, further comprising a flow controller configured to, when file retrieval for retrieving a video file, which need not be performed in real time, is requested during the rebuilding, perform flow control to retrieve a video file redundantly held.

9. The video server of claim 1, wherein
when processing other than the rebuilding is requested during the rebuilding, the allocator determines whether resources for performing the requested processing are available,
when the allocator determines that resources for performing the requested processing are available, the allocator allocates available resources to the requested processing, and
when the allocator determines that resources for performing the requested processing are not available, the allocator deallocates resources allocated to the rebuilding to secure resources for performing the requested processing, and allocates the secured resources to the requested processing.

10. The video server of claim 9, further comprising:
an error correction decoder configured to perform error correction decoding on the video data or video file generated by the restoration module, based on an error correction code;
an error correction decoder configured to add an error correction code to the video data or video file subjected to the error correction decoding, and output the video data or video file including the error correction code to the redundant data adder; and
a priority controller configured to, when a process other than the rebuilding is requested during the error correction decoding in the rebuilding, cause the error correction encoder to temporarily hold the video data or video file under the error correction decoding.

11. The video server of claim 9, further comprising:
an error correction decoder configured to perform error correction decoding on the video data or video file generated by the restoration module, based on an error correction code;
an error correction decoder configured to add an error correction code to the video data or video file subjected to the error correction decoding, and output the video data or video file including the error correction code to the redundant data adder; and
a priority controller configured to, when processing other than the rebuilding is requested during the addition of an error correction code in the rebuilding, cause the error correction encoder to temporarily hold the video data or video file under the addition of an error correction code.

12. The video server of claim 9, further comprising a priority controller configured to, when processing other than the rebuilding is requested while the data elements and redundant data stored in the replaced storage device are being written in the replacement storage device in the rebuilding, cause the write module to temporarily hold the video data or video file under the writing.

13. The video server of claim 9, further comprising a priority controller configured to, when processing other than the rebuilding is requested while the data elements and redundant data stored in the storage devices other than the replacement storage device are being read in the rebuilding, cause the read module to temporarily hold the video data or video file under the reading.

14. A rebuilding control method for use in a video server comprising a plurality of storage devices in which a plurality of data elements and redundant data are stored, the data elements being obtained by dividing video data or a video file by Redundant Array of Independent Disks (RAID) control, the redundant data being used for restoring the data elements, the method comprising:
when a storage device of the plurality of storage devices is replaced with a replacement storage device, allocating resources to rebuilding for rebuilding data elements and redundant data stored in the replaced storage device in the replacement storage device;
when processing which needs to be performed in real time is requested during the rebuilding, determining whether resources for performing the requested processing are available;
when resources for performing the requested processing are available, allocating available resources to the requested processing; and
when resources for performing the requested processing are not available, deallocating resources allocated to the rebuilding to secure resources for performing the requested processing, and allocating the secured resources to the requested processing.

15. The rebuilding control method of claim 14, further comprising, when processing which needs to be performed in real time is requested during error correction on video data or a video file generated based on data elements and redundant data read from the storage devices other than the replacement storage device, temporarily holding the video data or video file under the error correction.

16. The rebuilding control method of claim 14, further comprising, when processing which needs to be performed in real time is requested while an error correction code is being added to video data or a video file generated based on data elements and redundant data read from the storage devices other than the replacement storage device, temporarily holding the video data or video file under the addition of an error correction code.

17. The rebuilding control method of claim 14, further comprising, when processing which needs to be performed in real time is requested while data elements and redundant data stored in the replaced storage device are being written in the replacement storage device in the rebuilding, temporarily holding the video data or video file under the writing.

18. The rebuilding control method of claim 14, further comprising, when processing which needs to be performed in real time is requested while data elements and redundant data stored in the storage devices other than the replacement storage device are being read in the rebuilding, temporarily holding the video data or video file under the reading.

19. The rebuilding control method of claim 14, further comprising, when file storage for storing a video file, which need not be performed in real time, is requested during the rebuilding, suspending the file storage.

20. The rebuilding control method of claim 14, further comprising, when file retrieval for retrieving a video file, which need not be performed in real time, is requested during the rebuilding, retrieving a video file redundantly held.
